(19) United States
(12) Patent Application Publication
(10) Pub. No.: US 2025/0150186 A1
(43) Pub. Date: May 8, 2025

(54) METHOD AND APPARATUS FOR VALIDATING MACHINE-LEARNING-BASED PREDICTIONS OF LINE-OF-SIGHT INDICATOR VALUES

(71) Applicant: Nokia Technologies Oy, Espoo (FI)

(72) Inventors: Fahad SYED MUHAMMAD, Orsay (FR); Deepa MALAPATI RAVINDRAIAH, Bangalore (IN); Afef FEKI, Sceaux (FR); Dimitri GOLD, Espoo (FI)

(21) Appl. No.: 18/931,323

(22) Filed: Oct. 30, 2024

(30) Foreign Application Priority Data
Nov. 4, 2023 (IN) 202341075325

(51) Int. Cl. H04B 17/391; H04W 64/00

(52) U.S. Cl. CPC H04B 17/3912; H04W 64/00

(57) ABSTRACT

Test equipment (TE) may, while in a test configuration, cause transmission of a first reference signal for receipt by a communication device under test (DUT). The TE may receive a first line-of-sight indicator value as determined by the DUT in accordance with a method having a known accuracy. While in the test configuration, the TE may cause transmission of a second reference signal for receipt by the DUT. The TE may receive a second line-of-sight indicator value as determined by the DUT based at least in part on a trained machine learning (ML) model. The TE may determine an error value between the first line-of-sight indicator value and the second line-of-sight indicator value. Based at least in part on the error value, the TE may determine whether the trained ML model passes a conformance test related to estimation of line-of-sight indicator values by the trained ML model.

### TECHNOLOGICAL FIELD

An example embodiment relates generally to wireless communications and, more particularly, but not exclusively, to a method, apparatus and computer program product for validating machine-learning-based predictions of line-of-sight indicator values.

### BACKGROUND

Some communication devices may be capable of transmitting and receiving communications in various propagation environments that have different signal propagation characteristics. Some propagation environments may be conducive to or otherwise enable line-of-sight (LOS) communications between communication devices, while other propagation environments may prevent or reduce a likelihood of LOS communications between communication devices. For example, a propagation environment may include multiple obstacles situated between communication devices or weather conditions that reduce a likelihood of communications propagating along a straight path. To improve communication reliability and positioning accuracy, communication devices may be configured to determine LOS indicator values that indicate a probability for LOS communications. An LOS indicator value may then be utilized to inform adjustment of one or more communication parameters or to inform positioning decisions for communication devices, such that communication reliability and positioning accuracy may be improved.

A communication device may utilize a variety of techniques for determining LOS indicator values. In some examples, a communication device may determine an LOS indicator value using a technique that includes the utilization of a machine learning (ML) model to determine the LOS indicator value. However, utilizing ML for the determination of LOS indicator values may present various challenges. For example, LOS indicator values determined or otherwise generated by an ML model may be inaccurate or may otherwise be associated with uncertainty or prediction error. For example, an ML model may output LOS indicator values that are different from ground truth LOS indicator values, which may be undesirable.

### BRIEF SUMMARY

In accordance with one or more examples described herein, one or more operations may be performed to validate or otherwise determine one or more error values for line-of-sight (LOS) indicator values determined using machine learning (ML) or any other type of artificial intelligence (AI) model or functionality. For example, a first communication device (e.g., a device under test (DUT), a user equipment (UE), or the like) may determine a first LOS indicator value for a specific scenario (e.g., for a specific propagation environment or test configuration) without using ML. The first LOS indicator value may be an example of a ground truth LOS indicator value. The first communication device may then determine a second LOS indicator value for the specific scenario using ML. The first communication device may transmit the first LOS indicator value and the second LOS indicator value to a second communication device (e.g., test equipment (TE), a transmit receive point (TRP), a next-generation Node B (gNB)), which may determine an error value (e.g., for the second LOS indicator value) based on a comparison or a difference between the first LOS indicator value and the second LOS indicator value. In some examples, the second communication device may determine whether the AI/ML model, functionality used to determine the second LOS indicator value, or the first communication device itself passes a conformance test based on the error value. In this way, the first communication device may more accurately determine LOS indicator values, which may enable a wireless communication system to more effectively and more accurately adjust communication parameters and perform positioning operations.

In one aspect, a method includes, while in a test configuration, causing transmission of a first reference signal for receipt by a DUT; receiving a first line-of-sight indicator value as determined by the DUT in accordance with a method having a known accuracy and indicative of a first probability of the DUT having a line-of-sight component during reception of the first reference signal; while in the test configuration, causing transmission of a second reference signal for receipt by the DUT; receiving a second line-of-sight indicator value as determined by the DUT based at least in part on a trained ML model and indicative of a second probability of the DUT having a line-of-sight component during reception of the second reference signal; determining an error value between the first line-of-sight indicator value and the second line-of-sight indicator value; and based at least in part on the error value, determining whether the trained ML model passes a conformance test related to estimation of line-of-sight indicator values by the trained ML model.

In one embodiment, the method includes repeatedly causing transmission of the first reference signal and receiving the first line-of-sight indicator value for each of a plurality of different test configurations, thereby yielding a plurality of first line-of-sight indicator values; and repeatedly causing transmission of the second reference signal and receiving the second line-of-sight indicator value for each of the plurality of different test configurations, thereby yielding a plurality of second line-of-sight indicator values. In one embodiment, the method includes determining a plurality of error values between the plurality of first line-of-sight indicator values and the plurality of second line-of-sight indicator values; and determining whether the trained ML model passes the conformance test based at least in part on the plurality of error values. In one embodiment, determining whether the trained ML model passes the conformance test comprises: determining an average error value for the plurality of error values; and determining whether the trained ML model passes the conformance test based at least in part on whether the average error value satisfies a threshold error value.

In one embodiment, the method includes causing a data object to be stored that comprises the first line-of-sight indicator value associated with an indication of the test configuration.

In one embodiment, the method includes configuring the DUT pursuant to the test configuration. In one embodiment, the test configuration is associated with a particular channel profile as emulated by a channel emulator. In one embodiment, the test configuration is associated with a particular controlled radio propagation environment comprising one line-of-sight radio propagation path and/or one or more non-line-of-sight radio propagation paths. In one embodiment, the test configuration comprises zero, one or more reflectors and/or obstacles at respective positions and respective orientations with respect to an antenna configured to transmit the first and second reference signals.

In one embodiment, the first line-of-sight indicator value is determined in a manner independent of ML. In one embodiment, the first and second reference signals are positioning reference signals. In one embodiment, the method includes, before causing transmission of the first reference signal, configuring the DUT to determine the first line-of-sight indicator value in accordance with the method having the known accuracy; and before causing transmission of the second reference signal, configuring the DUT to determine the second line-of-sight indicator value based at least in part on the trained ML model.

In one aspect, an apparatus includes at least one processor; and at least one memory storing instructions that, when executed by the at least one processor, cause the apparatus to at least perform: while in a test configuration, cause transmission of a first reference signal for receipt by a DUT; receive a first line-of-sight indicator value as determined by the DUT in accordance with a method having a known accuracy and indicative of a first probability of the DUT having a line-of-sight component during reception of the first reference signal; while in the test configuration, cause transmission of a second reference signal for receipt by the DUT; receive a second line-of-sight indicator value as determined by the DUT based at least in part on a trained ML model and indicative of a second probability of the DUT having a line-of-sight component during reception of the second reference signal; determine an error value between the first line-of-sight indicator value and the second line-of-sight indicator value; and based at least in part on the error value, determine whether the trained ML model passes a conformance test related to estimation of line-of-sight indicator values by the trained ML model.

In one embodiment, the instructions further cause the apparatus to: repeatedly cause transmission of the first reference signal and receive the first line-of-sight indicator value for each of a plurality of different test configurations, thereby yielding a plurality of first line-of-sight indicator values; and repeatedly cause transmission of the second reference signal and receive the second line-of-sight indicator value for each of the plurality of different test configurations, thereby yielding a plurality of second line-of-sight indicator values. In one embodiment, the instructions further cause the apparatus to: determine a plurality of error values between the plurality of first line-of-sight indicator values and the plurality of second line-of-sight indicator values; and determine whether the trained ML model passes the conformance test based at least in part on the plurality of error values. In one embodiment, the instructions that cause the apparatus to determine whether the trained ML model passes the conformance test comprise instructions, that when executed by the at least one processor, cause the apparatus to: determine an average error value for the plurality of error values; and determine whether the trained ML model passes the conformance test based at least in part on whether the average error value satisfies a threshold error value or any other error metric.

In one embodiment, the instructions further cause the apparatus to: cause a data object to be stored that comprises the first line-of-sight indicator value associated with an indication of the test configuration.

In one embodiment, the test configuration is associated with a particular channel profile as emulated by a channel emulator. In one embodiment, the test configuration is associated with a particular controlled radio propagation environment comprising one line-of-sight radio propagation path and/or one or more non-line-of-sight radio propagation paths. In one embodiment, the test configuration comprises zero, one or more reflectors and/or obstacles at respective positions and respective orientations with respect to an antenna configured to transmit the first and second reference signals.

In one embodiment, the first line-of-sight indicator value is determined in a manner independent of ML. In one embodiment, the first and second reference signals are positioning reference signals. In one embodiment, the instructions further cause the apparatus to: before causing transmission of the first reference signal, configure the DUT to determine the first line-of-sight indicator value in accordance with the method having the known accuracy; and before causing transmission of the second reference signal, configure the DUT to determine the second line-of-sight indicator value based at least in part on the trained ML model.

In one aspect, a non-transitory computer-readable storage medium comprises program instructions stored thereon that are configured to perform at least the following: while in a test configuration, causing transmission of a first reference signal for receipt by a DUT; receiving a first line-of-sight indicator value as determined by the DUT in accordance with a method having a known accuracy and indicative of a first probability of the DUT having a line-of-sight component during reception of the first reference signal; while in the test configuration, causing transmission of a second reference signal for receipt by the DUT; receiving a second line-of-sight indicator value as determined by the DUT based at least in part on a trained ML model and indicative of a second probability of the DUT having a line-of-sight component during reception of the second reference signal; determining an error value between the first line-of-sight indicator value and the second line-of-sight indicator value; and based at least in part on the error value, determining whether the trained ML model passes a conformance test related to estimation of line-of-sight indicator values by the trained ML model.

In one embodiment, the program instructions are further configured to: repeatedly cause transmission of the first reference signal and receive the first line-of-sight indicator value for each of a plurality of different test configurations, thereby yielding a plurality of first line-of-sight indicator values; and repeatedly cause transmission of the second reference signal and receive the second line-of-sight indicator value for each of the plurality of different test configurations, thereby yielding a plurality of second line-of-sight indicator values. In one embodiment, the program instructions are further configured to: determine a plurality of error values between the plurality of first line-of-sight indicator values and the plurality of second line-of-sight indicator values; and determine whether the trained ML model passes the conformance test based at least in part on the plurality of error values. In one embodiment, the instructions configured to determine whether the trained ML model passes the conformance test comprise instructions configured to: determine an average error value for the plurality of error values; and determine whether the trained ML model passes the conformance test based at least in part on whether the average error value satisfies a threshold error value.

In one embodiment, the program instructions are further configured to: cause a data object to be stored that comprises the first line-of-sight indicator value associated with an indication of the test configuration.

In one embodiment, the test configuration is associated with a particular channel profile as emulated by a channel emulator. In one embodiment, the test configuration is associated with a particular controlled radio propagation environment comprising one line-of-sight radio propagation paths and/or one or more non-line-of-sight radio propagation paths. In one embodiment, the test configuration comprises zero, one or more reflectors and/or obstacles at respective positions and respective orientations with respect to an antenna configured to transmit the first and second reference signals.

In one embodiment, the first line-of-sight indicator value is determined in a manner independent of ML. In one embodiment, the first and second reference signals are positioning reference signals. In one embodiment, the program instructions are further configured to: before causing transmission of the first reference signal, configure the DUT to determine the first line-of-sight indicator value in accordance with the method having the known accuracy; and before causing transmission of the second reference signal, configure the DUT to determine the second line-of-sight indicator value based at least in part on the trained ML model.

In one aspect, an apparatus comprises means for, while in a test configuration, causing transmission of a first reference signal for receipt by a DUT; means for receiving a first line-of-sight indicator value as determined by the DUT in accordance with a method having a known accuracy and indicative of a first probability of the DUT having a line-of-sight component during reception of the first reference signal; means for, while in the test configuration, causing transmission of a second reference signal for receipt by the DUT; means for receiving a second line-of-sight indicator value as determined by the DUT based at least in part on a trained ML model and indicative of a second probability of the DUT having a line-of-sight component during reception of the second reference signal; means for determining an error value between the first line-of-sight indicator value and the second line-of-sight indicator value; and means for, based at least in part on the error value, determining whether the trained ML model passes a conformance test related to estimation of line-of-sight indicator values, such as value(s) for the line-of-sight indicator and/or the non-line-of-sight indicator, by the trained ML model.

In one embodiment, the apparatus further comprises means for repeatedly causing transmission of the first reference signal and receiving the first line-of-sight indicator value for each of a plurality of different test configurations, thereby yielding a plurality of first line-of-sight indicator values; and means for repeatedly causing transmission of the second reference signal and receiving the second line-of-sight indicator value for each of the plurality of different test configurations, thereby yielding a plurality of second line-of-sight indicator values. In one embodiment, the apparatus further comprises means for determining a plurality of error values between the plurality of first line-of-sight indicator values and the plurality of second line-of-sight indicator values; and means for determining whether the trained ML model passes the conformance test based at least in part on the plurality of error values. In one embodiment, means for determining whether the trained ML model passes the conformance test comprises: means for determining an average error value for the plurality of error values; and means for determining whether the trained ML model passes the conformance test based at least in part on whether the average error value satisfies a threshold error value.

In one embodiment, the apparatus further comprises means for causing a data object to be stored that comprises the first line-of-sight indicator value associated with an indication of the test configuration.

In one embodiment, the apparatus further comprises means for configuring the DUT pursuant to the test configuration. In one embodiment, the test configuration is associated with a particular channel profile as emulated by a channel emulator. In one embodiment, the test configuration is associated with a particular controlled radio propagation environment comprising one line-of-sight radio propagation path and/or one or more non-line-of-sight radio propagation paths. In one embodiment, the test configuration comprises zero, one or more reflectors and/or obstacles at respective positions and respective orientations with respect to an antenna configured to transmit the first and second reference signals.

In one embodiment, the first line-of-sight indicator value is determined in a manner independent of ML. In one embodiment, the first and second reference signals are positioning reference signals. In one embodiment, the apparatus further comprises means for, before causing transmission of the first reference signal, configuring the DUT to determine the first line-of-sight indicator value in accordance with the method having the known accuracy; and means for, before causing transmission of the second reference signal, configuring the DUT to determine the second line-of-sight indicator value based at least in part on the trained ML model.

In one aspect, a test arrangement comprises an apparatus comprising at least one processor; and at least one memory storing instructions that, when executed by the at least one processor, cause the apparatus to at least perform: while in a test configuration, cause transmission of a first reference signal for receipt by a DUT; receive a first line-of-sight indicator value as determined by the DUT in accordance with a method having a known accuracy and indicative of a first probability of the DUT having a line-of-sight component during reception of the first reference signal; while in the test configuration, cause transmission of a second reference signal for receipt by the DUT; receive a second line-of-sight indicator value as determined by the DUT based at least in part on a trained ML model and indicative of a second probability of the DUT having a line-of-sight component during reception of the second reference signal; determine an error value between the first line-of-sight indicator value and the second line-of-sight indicator value; and based at least in part on the error value, determine whether the trained ML model passes a conformance test related to estimation of line-of-sight indicator values by the trained ML model. The test arrangement also includes an anechoic chamber in which is disposed: one or more antennas coupled with the apparatus, wherein the first reference signal and the second reference signal are transmitted to the DUT via the one or more antennas; zero, one or more reflectors configured to reflect a reference signal towards the DUT; zero, one or more obstacles configured to block a reference signal towards the DUT; and the DUT, wherein the DUT is configured to communicate with the apparatus. Although some examples described herein may refer to specific combinations of operations being performed together, any combination of the operations described herein may be performed. For example, an example embodiment may include any combination of the operations described herein.

### BRIEF DESCRIPTION OF THE DRAWINGS

Having thus described certain example embodiments of the present disclosure in general terms, reference will be made herein to the accompanying drawings, which are not necessarily drawn to scale, and wherein:

FIGS. 1A and 1B illustrate examples of test arrangements that support validation of machine-learning-based predictions of line-of-sight indicator values;

FIG. 2 illustrates an apparatus that supports validation of machine-learning-based predictions of line-of-sight indicator values;

FIGS. 3A and 3B illustrate examples of propagation environments that support validation of machine-learning-based predications of line-of-sight indicator values;

FIG. 4 is a flowchart of operations according to certain example embodiments implemented, for example, by an apparatus as described herein;

FIGS. 5A and 5B illustrate signaling diagrams that support validation of machine-learning-based predications of line-of-sight indicator values;

FIG. 6 illustrates an example of a signaling flow diagram that provides examples of signaling associated with validation of machine-learning-based predictions of line-of-sight indicator values; and

FIG. 7 is a flowchart of operations according to certain example embodiments implemented, for example, by an apparatus as described herein.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with certain embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

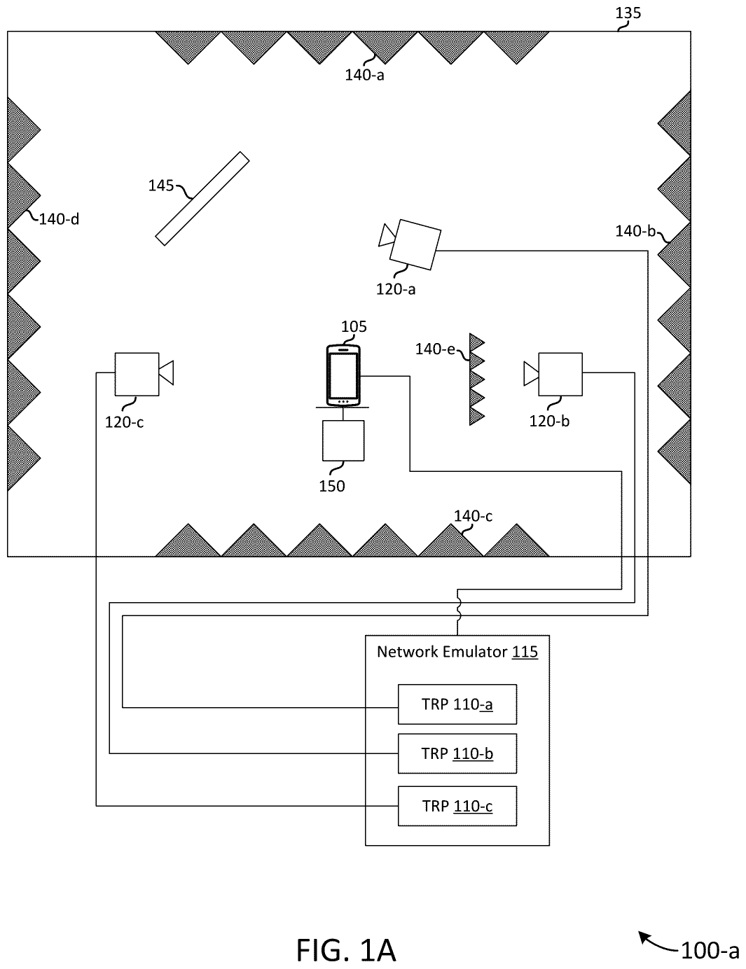

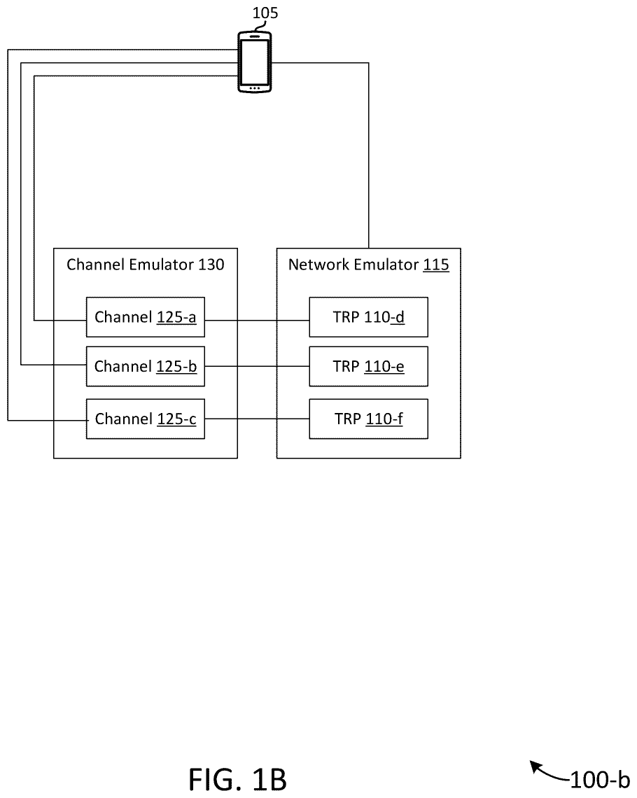

FIG. 1A illustrates an example of a test arrangement 100-a that supports validation of machine-learning-based predictions in accordance with examples described herein. The test arrangement 100-a may be an example of a configurable test system capable of supporting multiple test configurations. The test arrangement 100-a may include one or more transmit receive points (TRPs) 110 (e.g., one or more first communication devices, such as one or more transmitters, receivers or transceivers), which may communicate with a device under test (DUT) 105 (e.g., a second communication device). In some examples, the DUT 105 may be an example of a user equipment (UE). In some examples, a network emulator 115 (e.g., a system simulator (SS), test equipment (TE)) may include the one or more TRPs 110. The test arrangement 100-a may include one or more antennas 120, which may be utilized for transmitting and receiving signals between TRPs 110 and the DUT 105. In some examples, the test arrangement 100-a may be utilized for a specific range of frequencies (e.g., frequency range 2 (FR2)).

In some examples, communications between the DUT 105 and the one or more TRPs 110 may propagate or otherwise be transmitted along various paths. For example, the TRP 110-c may transmit or cause transmission of communication signals (e.g., via the antenna 120-c) to the DUT 105 via a line-of-sight (LOS) path. In some examples, such communications may be referred to as LOS communications. As described herein, LOS communications may travel or otherwise propagate from one communication device directly to another communication device (e.g., along a straight path) without changing direction (e.g., without being reflected, scattered, refracted, absorbed, or diffracted). In some other examples, a TRP 110 may transmit or cause transmission of communication signals to the DUT 105 via a non-line-of-sight (NLOS) path. Communications that propagate via an NLOS path may travel from one communication device to another communication device via an indirect path, such as by experiencing reflections and/or blockages. For example, the TRP 110-a may transmit (e.g., via the antenna 120-a) communications to the DUT 105, which may propagate in a first direction (e.g., towards a reflector 145), and may then propagate in a second direction (e.g., towards the DUT 105) after being reflected by the reflector 145. As another example, the TRP 110-b may transmit (e.g., via the antenna 120-b) communications to the DUT 105, which may be at least partially absorbed by one or more blockages, such as the absorber 140-c.

In some examples, the operations described herein may be performed within an anechoic chamber 135. The anechoic chamber 135 may reduce or eliminate reflections of communications from the sidewalls of the chamber, which may enable one or more parameters associated with a communication path to be controlled or configured for a specific test configuration. In some examples, the anechoic chamber 135 may enable the isolation of one or more communication paths between the DUT 105 and an antenna 120. For example, the DUT 105 may receive communication signals from the antenna 120-a that are reflected off of the reflector 145 without receiving communication signals that are reflected off of walls of the anechoic chamber 135. In some examples, the anechoic chamber 135 may include one or more TRPs 110 that have LOS communication paths to the DUT 105 and one or more TRPs 110 that do not have LOS communication paths to the DUT 105 (e.g., NLOS communications only via one or more reflectors 145).

Although some examples described herein refer to operations performed in the anechoic chamber 135, the operations described herein may be performed in other contexts, without loss of meaning. For example, the operations described herein may be performed outdoors or otherwise outside of the anechoic chamber 135. In such cases, a network entity such as a base station or a next-generation Node B (gNB) may perform the operations otherwise described herein as being performed by the network emulator 115 and the one or more antennas 120. Additionally, or alternatively, a UE may perform the operations otherwise described herein as being performed by the DUT 105.

The anechoic chamber 135 may include one or more absorbers or obstacles 140, which may function to block, reduce, or eliminate propagations of radio waves. As described herein, one or more absorbers 140 may be installed within the anechoic chamber 135 in any configuration, pattern, or arrangement. In one illustrative example, an absorber 140 may be adhered to each wall of the anechoic chamber 135.

The anechoic chamber 135 may include a positioning device 150, which may be operable to adjust a position of the DUT 105. For example, a control component (e.g., a controller, a computing entity) of the test arrangement 100-a may transmit a control signal to the positioning device 150. The control signal may cause the positioning device 150 to move or rotate the DUT 105. In some other examples, the positioning device 150 may be operated manually or a position of the DUT 105 may be adjusted manually without the positioning device 150. In accordance with one or more examples described herein, adjusting a position of the DUT 105 may affect whether the DUT 105 receives communications (e.g., from one or more antennas 120) via an LOS or an NLOS path. For example, the DUT 105 may receive LOS communications from the TRP 110-b (e.g., via the antenna 120-b) via an LOS path when the DUT 105 is located in a first position. The positioning device 150 may adjust a position of the DUT 105 from the first position to a second position and the DUT 105 may then receive NLOS communications from the TRP 110-b (e.g., via the antenna 120-b).

The components of the test arrangement 100-a may be configured in accordance with one or more test configurations. The one or more test configurations may be utilized for testing the accuracy of various LOS indicator values determined (e.g., predicted) by the DUT 105. For example, a test configuration may be utilized to determine an accuracy of a first technique for determining an LOS indicator value (e.g., a technique using machine learning (ML)) relative to a second technique for determining the LOS indicator value (e.g., a technique that does not use ML, but that yields ground-truth LOS indicator values with a known accuracy).

As described herein, the term “LOS indicator value” may refer to a value that indicates a probability of communications between two communication devices being LOS communications. In some examples, an LOS indicator value may be a percentage or a soft value. For example, an LOS indicator value of 90% or 0.9 may indicate a 90% probability that communications between a DUT 105 and a TRP 110 will be LOS communications. An LOS indicator value of 10% or 0.1 may indicate a 10% probability that communications between a DUT 105 and a TRP 110 will be LOS communications. In some other examples, an LOS indicator value may be a hard value. For example, a value of “1” may correspond to LOS communications or 100% certainty for LoS communications, and a value of “0” may correspond to NLOS communications or 100% certainty for no LOS communications.

In some examples, an LOS indicator value may be based on or otherwise determined in response to a reference signal. For example, a DUT 105 may receive a reference signal from a TRP 110 and may determine an LOS indicator value based on the reference signal. In some examples, the LOS indicator value may indicate a probability of the DUT 105 having an LOS component during reception of the reference signal. In some examples, the terms “LOS indicator value” and “LOS/NLOS indicator value” may be used interchangeably herein.

In some examples, tests may be performed for an array of expected LOS indicator values, where each expected LOS indicator value corresponds to a particular test configuration. For example, a first test configuration may correspond to an LOS indicator value of 100%, which may be indicative of a 100% probability that communications between the DUT 105 and a TRP 110 will be LOS communications. In some examples, the LOS indicator value may be indicative of a probability that the DUT 105 will have an LOS component during reception of a reference signal from the TRP 110. In one example, for the first test configuration, the DUT 105 and an antenna 120 may be positioned in locations corresponding to a 100% probability that communications between the DUT 105 and the antenna 120 will be LOS communications. After one or more tests using the first test configuration, one or more of the DUT 105 and/or the reflectors 145 and/or the absorbers/obstacles 140 and/or the antenna 120 may be repositioned in accordance with a second test configuration (e.g., corresponding to another expected LOS indicator value, such as 75% probability that communications between the DUT 105 and the antenna 120 will be LOS communications).

As described herein, a test configuration may include one or more objects (e.g., communication devices, absorbers/obstacles 140, reflectors 145, positioning devices 150) arranged in specific locations, which may result in specific communication conditions (e.g., specific propagation environments). For example, a test configuration may correspond to a specific scenario or probability for LOS communications between two communication devices (e.g., the DUT 105 and a TRP 110). Alternatively, a test configuration may include one or more communication parameters that are configured for specific communication conditions.

FIG. 1B illustrates an example of a test arrangement 100-b that supports validation of machine-learning-based predictions in accordance with examples described herein. The test arrangement 100-b may be an example of a configurable test system capable of supporting multiple test configurations. In some examples, the test arrangement 100-b may be an example of a test configuration utilized for a specific range of frequencies (e.g., frequency range 1 (FR1)). The test arrangement 100-b may include one or more TRPs 110 (e.g., one or more first communication devices, such as one or more transmitters, receivers or transceivers), which may communicate with a DUT 105 (e.g., a second communication device). In some examples, the one or more TRPs 110 may be coupled to the DUT 105 via a channel emulator 130 using one or more wired connections. For instance, internal antenna connectors may be provisioned within the one or more TRPs 110 and the DUT 105 for wired connection to the channel emulator 130. In some examples, the DUT 105 may be an example of a UE. In some examples, a network emulator 115 (e.g., an SS, TE) may include the one or more TRPs 110. In some examples, the one or more TRPs 110 may communicate with the DUT 105 via one or more channels 125 having respective channel profiles defining respective channel propagation characteristics. The one or more channels 125 may, in some examples, be generated by or included in a channel emulator 130.

As described herein, various techniques may be utilized to emulate the existence of an LOS or an NLOS path (e.g., to realize specific test configurations). For example, the channel emulator 130 may be utilized to generate one or more channels 125 that mimic LOS or NLOS paths. As an illustrative example, the TRP 110-d may communicate with the DUT 105 via the channel 125-a. The channel 125-a may emulate an NLOS path, and accordingly, communications between the TRP 110-d and the DUT 105 may exhibit one or more characteristics of NLOS communications. As another example, the TRP 110-e may communicate with the DUT 105 via the channel 125-b. The channel 125-b may emulate an LOS path, and accordingly, communications between the TRP 110-e and the DUT 105 may exhibit one or more characteristics of LOS communications.

In some examples, the test arrangement 100-b may enable one or more test operations to be performed automatically. For example, the test arrangement 100-b may enable one or more LOS indicator values (e.g., one or more test configurations) to be determined by the DUT 105 without manually arranging or configuring the antennas 120, the absorbers/obstacles 140, or the reflectors 145. In such examples, the channel emulator 130 may be configured to generate one or more channels 125 that mimic or reproduce conditions otherwise produced in the anechoic chamber 135.

In some examples, a test arrangement 100 may include components that may be described herein as test equipment (TE). For example, the network emulator 115 and the TRPs 110 included in the network emulator 115 may be referred to herein as “TE.” Accordingly, the DUT 105 may be described as communicating with TE, which may refer to TRPs 110 or the network emulator 115 more generally. Additionally, or alternatively, “TE” may refer to any component of the test arrangement 100, or any component utilized for performing one or more test operations involving the DUT 105. In some examples, TE may be utilized to emulate or simulate a wireless network (e.g., a wireless network that is deployed outside of a test environment). The TE (e.g., the test arrangement 100) may include any type of equipment found in a wireless network (e.g., in a real wireless network), such as gNBs, signal generators, probes, and TRPs 110 that are used to transmit radio signals of specific types (e.g., synchronization signal block (SSB) signals, timing reference signals (TRSs), etc.). Additionally, or alternatively, the TE may include reflectors 145 and/or attenuators/absorbers/obstacles 140 of the test arrangement 100-a, or the TE may include channel emulator 130 of the test arrangement 100-b, which may be used to emulate the propagation of wireless signals. The different propagation conditions may allow different LOS/NLOS conditions to be generated. Accordingly, reference LOS/NLOS probabilities may be selected for testing.

In some examples, the one or more DUTs 105 may be examples of user equipments (UEs). Outside of the anechoic chamber, the one or more DUTs 105 may be configured to communicate with a core network including one or more network nodes of the core network via, for example, a radio access network (RAN) including via one or more gNBs of the RAN. A UE that embodies the DUT may be configured to communicate in accordance with various radio access architectures, including those based on long term evolution advanced (LTE Advanced, LTE-A) and/or new radio (NR, 5G). However, the UE that embodies the DUT may be deployed in other network architectures including within other communication networks including, for example, other communication networks developed in the future, e.g., sixth generation (6G) networks, as well as any of a number of existing networks including a universal mobile telecommunication system (UMTS), radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The DUT 105 may be any type of user terminal, terminal device, node (e.g., network node), element (e.g., network element), etc. to which resources on the air interface are allocated and assigned. For example, the DUT 105 may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, car, truck, drone, airplane and other types of vehicles. As a non-exhaustive list of some examples, the DUT 105 may also be called a subscriber unit, mobile station, network element, remote terminal, access terminal, or user terminal.

In some examples, one or more communication devices (e.g., TRPs 110, UEs, DUTs 105) may be configured to perform various operations using ML or any other type of artificial intelligence (AI) model or functionality. In recent years, AI/ML use cases for the new radio (NR) air interface have been studied. One research objective is to better understand interoperability and testability for AI/ML-enabled features. For example, various areas of study include: (i) interoperability and testability aspects, (i) requirements and testing frameworks to validate AI/ML-based performance enhancements for ensuring that UEs and gNBs with AI/ML capabilities meet or exceed the various operational standards, and (iii) evaluation of the need for and implications associated with AI/ML processing capabilities.

Specifically, AI/ML-enabled positioning has been selected as a use case for further study. One sub-use case of AI/ML-enabled positioning is UE-based direct AI/ML positioning. Various key performance indicators (KPIs) and/or metrics are under study for use cases related to positioning. Some examples of KPIs and/or metrics are (i) positioning accuracy (e.g., ground truth data versus reported data), (ii) line-of-sight (LOS) indicators, (iii) path phase, (iv) reference signal timing difference (RSTD), and (v) positioning reference signal (PRS) reference signal received power (RSRP), among other examples. Of these KPIs, the positioning accuracy KPI may be utilized for direct positioning.

For the positioning use case (e.g., the AI/ML positioning use case), the following proposals for potential KPIs/test metrics have been under discussion: (i) direct positioning accuracy (ground truth vs. reported), (ii) RSTD/UE reception/transmission accuracy, (iii) channel impulse response (CIR)/power delay profile (PDP)/RSRP accuracy, and (iv) LOS/NLOS accuracy (e.g., accuracy of LOS indicator values). Two positioning approaches are under study: (i) direct AI/ML positioning where the output of the AI/ML model inference is a location of a UE and (ii) AI/ML-assisted positioning where the output of the AI/ML model is a new measurement and/or an enhancement to an existing measurement. This measurement includes, for example, LOS/NLOS identification, time of arrival (ToA), path phase, and RSTD, among other examples. There are multiple options for the input of the AI/ML model, including channel observations such as CIR, PDP, RSRP, and reference signal received path power (RSRPP), among other examples.

Five use-cases for AI/ML for the air interface are under study. The use-cases include: (i) UE-based positioning with UE-side model (direct AI/ML or AI/ML-assisted positioning), (ii) UE-assisted/location management function (LMF) based positioning with UE-side model (AI/ML-assisted positioning) (iii) UE-assisted/LMF-based positioning with LMF-side model (direct AI/ML positioning), (iv) NG-RAN-node-assisted positioning with gNB-side model (AI/ML-assisted positioning), and (v) NG-RAN-node-assisted positioning with LMF-side model (direct AI/ML positioning).

For UE-based positioning, determination of LOS indicator values may be an area of further study. For example, the use of LOS/NLOS indicator value determination as a test metric/KPI for performance evaluation is under consideration. To validate AI/ML-based methods, labelled data may be utilized. Labelled data may be of particular importance for supervised-learning-based solutions, which may be utilized for the use cases described herein. In some examples, labelled data generation may involve extraction of ground truth data, which may present challenges associated with various use cases, such as AI/ML-assisted positioning where AI/ML-based methods are used to provide LOS indicator values (e.g., LOS/NLOS indicator values) that are utilized in positioning methods that do not utilize AI/ML.

Various test mechanisms may be utilized for location estimation and latency estimation for global navigation satellite system (GNSS) based positioning. These test mechanisms are defined for various satellites and rely on GNSS measurements. However, there are no test mechanisms defined for verifying LOS indicator value determinations by a UE for PRS-based measurements. Currently, no mechanism exists for ground truth extraction (e.g., determination) of LOS indicator values (e.g., LOS indicator values with a known accuracy, ground truth LOS indicator values), which may be used to validate LOS indicator values determined using AI/ML. In some examples, LOS indicator values determined using AI/ML may be utilized for AI/ML-assisted positioning, which may present challenges associated with AI/ML-assisted positioning if LOS indicator values are inaccurate.

In some examples, the network (e.g., a TRP 110) may not have information related to AI/ML model/functionality accuracy. For example, the network may be unaware of AI/ML model accuracy or performance in terms of positioning. However, such information may be useful for the network in some contexts. For example, the network may monitor one or more KPIs of the AI/ML model to initiate life cycle management (LCM) based procedures (e.g., model reselection, update, switching, deactivation, etc.). Additionally, or alternatively, LCM-based procedures, including monitoring, may be implemented by a UE (e.g., a DUT 105), where the accuracy/quality of LOS indicator value prediction/estimation against the ground truth may be useful.

Some positioning techniques assume that a UE reports measurements (e.g., RSRPP measurements, RSRP measurements, etc.) and then position (e.g., of the UE) is determined at a location management function (LMF). Therefore, such positioning techniques and associated test operations are not based on an actual position of the UE, but instead based on measurements reported by the UE, which in some cases may be inaccurate or associated with errors due to reporting latency. In the case of UE-based positioning, the indication of LOS indicator values may be used as input for deriving the location coordinates either at the UE or at the network (e.g., at a gNB or LMF). However, no requirements and tests are defined to verify the UE-based positioning functionalities, such as UE determination of LOS indicator values.

Some positioning methods, such as assisted GNSS (A-GNSS), may have performance requirements for location estimation and latency for GNSS-based positioning. However, no test mechanisms are defined for extracting the ground truth that may be used for verifying the LOS indicator values as the intermediate feature of the UE for PRS-based measurements. The indication of LOS indicator values may be the result of inference of the AI/ML model for a TRP 110 which may be used as input for an AI/ML-based or non-AI/ML-based algorithm at the UE or at the network (e.g., at a gNB, at an LMF) to derive location coordinates. In some examples, one or more PRSs may be transmitted by multiple TRPs 110 in a network for performing positioning measurements.

However, no procedures exist for extracting ground truth that may be used for verification of the AI/ML model/functionality inference of LOS/NLOS indicator results. As described herein, the term “ground truth” may refer to information that indicates whether a UE (e.g., a DUT 105) is receiving a PRS signal directly from a TRP 110 (e.g., corresponding to an LOS condition) or if the PRS signal is received indirectly via multiple paths (e.g., via one or more reflected signals, corresponding to an NLOS condition). The ground truth information may have a known accuracy or may be utilized as a reference or benchmark for verifying other information that is measured with some degree of error or inaccuracy. Stated another way, ground truth information may be correct information or information that is accurate enough and, at least in some embodiments, may be determined in a manner that is independent of ML.

Hence, there is a need for defining a framework for determining the ground truth that may be used for verification of LOS indicator values determined using AI/ML functionalities. Such a framework may be utilized for AI/ML-based positioning as well as other use cases. The techniques described herein define such a framework for extracting the ground truth that may be used for verifying LOS indicator value inferences for UE-based or UE-assisted AI/ML positioning, among other examples. Specifically, the techniques described herein may be utilized for any AI/ML model/functionality for deriving LOS indicator values based on one or more received PRSs from one or more TRPs 110. In some examples, LOS indicator value determination (e.g., inference or prediction) using an AI/ML model/functionality may be tested and validated against labelled data in order to validate the trained model/functionality and its output. The “labels” are de facto trusted and represented as the ground truth. In some examples, the techniques described herein may utilize one or more PRS transmissions from one or more TRPs 110 of a network (e.g., from one or more gNBs, from one or more evolved Node Bs (eNBs), from test equipment (TE)).

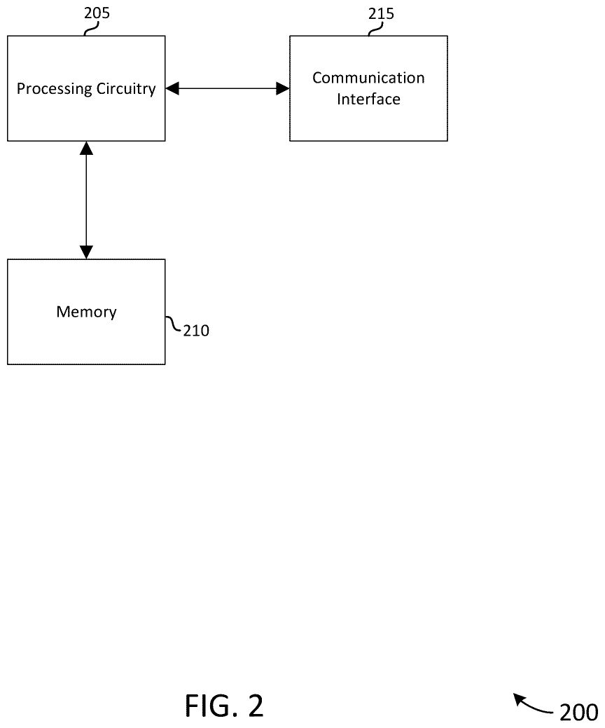

FIG. 2 illustrates an example of an apparatus 200 that supports validation of machine-learning-based predictions in accordance with examples described herein. The apparatus 200 may be embodied by or may comprise a communication device, such as a TE or other computing device or controller, configured to perform operations that determine error values associated with LOS indicator values. As shown in FIG. 2, the apparatus 200 may include, be associated with, or be in communication with processing circuitry 205 (e.g., one or more processors), a memory 210 and a communication interface 215. The processing circuitry 205 may be in communication with the memory 210 via a bus for passing information among components of the apparatus 200. The memory 210 may be non-transitory and may include, for example, one or more volatile and/or non-volatile memories. In other words, for example, the memory 210 may be an electronic storage device (e.g., a computer readable storage medium) comprising storage components configured to store data (e.g., bits) that may be retrievable by a machine (e.g., a computing device like the processing circuitry 205). The memory 210 may be configured to store information, data, content, applications, instructions, or the like for enabling the apparatus 200 to carry out various functions in accordance with an example embodiment of the present disclosure. Additionally, or alternatively the memory 210 may be configured to store instructions for execution by the processing circuitry 205.

The apparatus 200 may, in some embodiments, be embodied in various computing devices as described above. However, in some embodiments, the apparatus 200 may be embodied as a chip or chip set. In other words, the apparatus 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 may therefore, in some examples, be configured to implement an embodiment of the present invention on a single chip or as a single “system on a chip.” As such, in some examples, a chip or chipset may constitute means for performing one or more operations for providing the functionalities described herein.

The processing circuitry 205 may be embodied in a number of different ways. For example, the processing circuitry 205 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 205 may include one or more processing cores configured to perform independently. A multi-core processing circuitry may enable multiprocessing within a single physical package. Additionally, or alternatively the processing circuitry 205 may include one or more processors configured in tandem via the bus to enable independent execution of instructions, pipelining and/or multithreading.

In an example embodiment, the processing circuitry 205 may be configured to execute instructions stored in the memory 210 or otherwise accessible to the processing circuitry 205. Additionally, or alternatively, the processing circuitry 205 may be configured to execute hard coded instructions. As such, whether configured by hardware or software methods, or by a combination thereof, the processing circuitry 205 may represent an entity (e.g., physically embodied in circuitry) capable of performing operations according to an embodiment of the present disclosure while configured accordingly. Thus, for example, when the processing circuitry 205 is embodied as an ASIC, FPGA or the like, the processing circuitry 205 may be specifically configured hardware for conducting the operations described herein. Alternatively, as another example, when the processing circuitry 205 is embodied as an executor of instructions, the instructions may specifically configure the processing circuitry 205 to perform the algorithms and/or operations described herein when the instructions are executed. However, in some examples, the processing circuitry 205 may be a processor of a specific device (e.g., an image or video processing system) configured to employ an embodiment of the present invention by further configuration of the processing circuitry 205 by instructions for performing the algorithms and/or operations described herein. The processing circuitry 205 may include, among other things, a clock, an arithmetic logic unit (ALU) and logic gates configured to support operation of the processing circuitry 205.

The communication interface 215 may be any means such as a device or circuitry embodied in either hardware or a combination of hardware and software that is configured to receive and/or transmit data, including media content in the form of video or image files, one or more audio tracks or the like. In this regard, the communication interface 215 may include, for example, an antenna (or multiple antennas) and supporting hardware and/or software for enabling communications with a wireless communication network. Additionally, or alternatively the communication interface 215 may include one or more antennas to cause transmission of signals via the one or more antennas or to handle receipt of signals received via the one or more antennas. In some environments, the communication interface 215 may alternatively or also support wired communication. As such, for example, the communication interface 215 may include a communication modem and/or other hardware/software for supporting communication via cable, digital subscriber line (DSL), universal serial bus (USB) or other mechanisms.

In some examples, the apparatus 200 may perform one or more operations to validate or otherwise determine one or more error values for LOS indicator values determined using ML. For example, the apparatus 200 may transmit or cause transmission of a first reference signal (e.g., a positioning reference signal (PRS) and may receive (e.g., from another apparatus 200, from a DUT 105) a first indication of a first LOS indicator value for a specific scenario (e.g., for a propagation environment, for a test configuration) without using ML. The first LOS indicator value may be an example of a ground truth LOS indicator value. The apparatus 200 may then transmit or cause transmission of a second reference signal (e.g., a second PRS) and may receive a second indication of a second LOS indicator value for the same specific scenario using ML. The apparatus 200 may then determine an error value (e.g., for the second LOS indicator value) based on a comparison or a difference between the first LOS indicator value and the second LOS indicator value. In some examples, the apparatus 200 may determine whether an AI/ML model or functionality passes a conformance test based on the error value. If the AI/ML model or functionality passes the conformance test, the AI/ML model or functionality may be placed into service, while an AI/ML model or functionality that fails the conformance test may not be placed into service and, instead, may be redesigned or otherwise reworked. Accordingly, determining the error value may enable the apparatus 200 to improve communication reliability and positioning accuracy by ensuring that the AI/ML models that are placed into service are able to accurately determine an appropriate LOS indicator value. For example, the AI/ML model or functionality that has been tested and passed the conformance test may be ensured to more accurately determine LOS indicator values, which may enable the apparatus 200 to more effectively and more accurately adjust communication parameters and perform positioning operations.

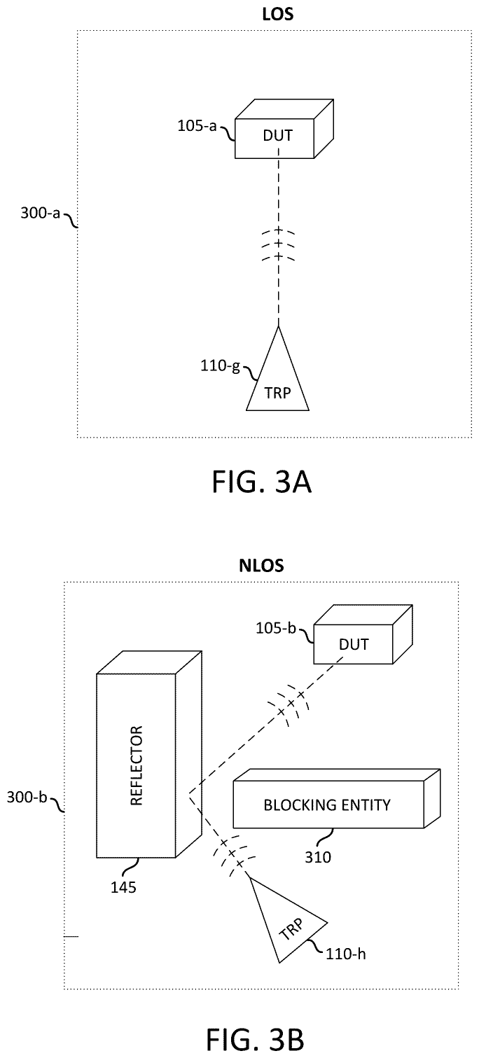

FIG. 3A illustrates an example of a propagation environment 300-a that supports validation of machine-learning-based predictions in accordance with examples described herein. The propagation environment 300-a may be an example of an LOS propagation environment. The propagation environment 300-a may include a TRP 110-g and a DUT 105-a, which may be examples of corresponding TRPs 110 and DUTs 105 as described with reference to FIGS. 1A and 1B. The TRP 110-g and the DUT 105-a may be in communication with one another and may communicate via an LOS path (straight line path). For example, the TRP 110-g may cause transmission of one or more reference signals (e.g., PRSs) towards the DUT 105-a and the DUT 105-a may determine and cause transmission of one or more LOS indicator values towards the TRP 110-g. The one or more LOS indicator values may correspond to the propagation environment 300-a or the propagation path utilized for communication of the one or more reference signals.

In some examples, the propagation environment 300-a may be an example of a test configuration. For example, the propagation environment 300-a may be an example of a test configuration utilized for determining one or more LOS indicator values for a specific scenario or test case, such as an LOS scenario. Accordingly, the TRP 110-g and the DUT 105-a may be configured in accordance with the test configuration (e.g., as shown). The propagation environment 300-a may be utilized for testing the accuracy of various LOS indicator values determined (e.g., predicted) by the DUT 105-a using different methods. For example, the propagation environment 300-a may be utilized to determine an accuracy of a first technique for determining an LOS indicator value (e.g., a technique using machine learning (ML)) relative to a second technique for determining the LOS indicator value (e.g., a technique that does not use ML, a technique that yields ground-truth LOS indicator values, a technique having a known accuracy).

In accordance with one or more examples described herein, the DUT 105-a may determine a first LOS indicator value for the propagation environment 300-a without using ML (e.g., using a method having a known accuracy). The DUT 105-a may determine the first LOS indicator value based on a first reference signal received from the TRP 110-g. The first LOS indicator value may be an example of a ground truth LOS indicator value. The DUT 105-a may then determine a second LOS indicator value for the propagation environment 300-a using ML. In some examples, the DUT 105-a may determine the second LOS indicator value based on a second reference signal received from the TRP 110-g. The DUT 105-a may then transmit the first LOS indicator value and the second LOS indicator value to the TRP 110-g. An error value (e.g., for the second LOS indicator value) may then be determined based on a comparison or a difference between the first LOS indicator value and the second LOS indicator value. In some examples, it is then determined whether the ML model passes a conformance test based on the error value.

FIG. 3B illustrates an example of a propagation environment 300-b that supports validation of machine-learning-based predictions in accordance with examples described herein. The propagation environment 300-b may be an example of an NLOS propagation environment. The propagation environment 300-b may include a TRP 110-h and a DUT 105-b, which may be examples of corresponding TRPs 110 and DUTs 105 as described with reference to FIGS. 1A and 1B. Additionally, or alternatively, the propagation environment 300-b may include a reflector 145 and a blocking entity 310. The reflector 145 may be an example of the reflector 145 described with reference to FIG. 1A. In some examples, the blocking entity 310 may block communications from being transmitted directly (e.g., along an LOS path) between the TRP 110-h and the DUT 105-b. Accordingly, communications between the TRP 110-h and the DUT 105-b may be reflected by the reflector 305 and propagate along an NLOS path.

In some examples, the TRP 110-h may cause transmission of one or more reference signals (e.g., PRSs) towards the DUT 105-b. The one or more reference signals may propagate or otherwise travel around the blocking entity 310 (e.g., along an NLOS path). The DUT 105-b may determine and cause transmission of one or more LOS indicator values towards the TRP 110-h. The one or more LOS indicator values may correspond to the propagation environment 300-b or the propagation path utilized for communication of the one or more reference signals.

In some examples, the propagation environment 300-b may be an example of a test configuration. For example, the propagation environment 300-b may be an example of a test configuration utilized for determining one or more LOS indicator values for a specific scenario or test case, such as an NLOS scenario. Accordingly, the TRP 110-h, the DUT 105-b, the blocking entity 310, and the reflector 145 may be configured in accordance with the test configuration (e.g., as shown). The propagation environment 300-b may be utilized for testing the accuracy of various LOS indicator values determined (e.g., predicted) by the DUT 105-b using different methods. For example, the propagation environment 300-b may be utilized to determine an accuracy of a first technique for determining an LOS indicator value (e.g., a technique using machine learning (ML)) relative to a second technique for determining the LOS indicator value (e.g., a technique that does not use ML, a technique that yields ground-truth LOS indicator values, a technique having a known accuracy).

In accordance with one or more examples described herein, the DUT 105-b may determine a first LOS indicator value for the propagation environment 300-b without using ML (e.g., using a method having a known accuracy). The DUT 105-b may determine the first LOS indicator value based on a first reference signal received from the TRP 110-h (e.g., a first reference signal that propagates along an NLOS path). The first LOS indicator value may be an example of a ground truth LOS indicator value. The DUT 105-b may then determine a second LOS indicator value for the same propagation environment 300-b using ML. In some examples, the DUT 105-b may determine the second LOS indicator value based on a second reference signal received from the TRP 110-h (e.g., a second reference signal that propagates along the NLOS path). The DUT 105-b may then transmit the first LOS indicator value and the second LOS indicator value to the TRP 110-h. An error value (e.g., for the second LOS indicator value) may then be determined based on a comparison or a difference between the first LOS indicator value and the second LOS indicator value. In some examples, it is then determined whether the ML model passes a conformance test based on the error value.

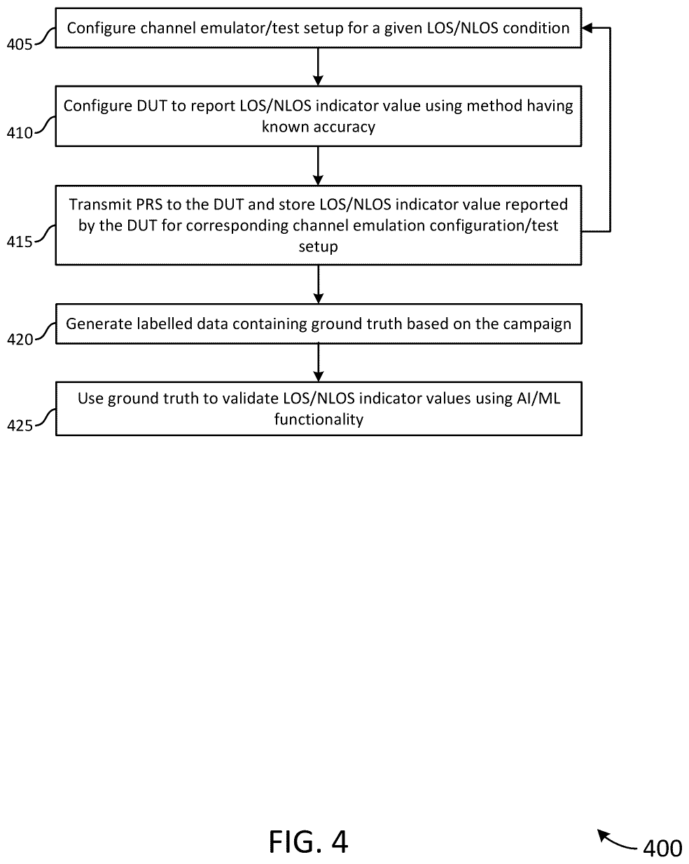

FIG. 4 illustrates an example of a flowchart 400 that supports validation of machine-learning-based predictions in accordance with examples described herein. The flowchart 400 may provide an illustrative example of one or more operations performed by one or more devices to validate or otherwise determine an accuracy for one or more LOS indicator determinations. For example, one or more of the operations of the flowchart 400 may be performed by TE (e.g., a TRP 110, a network emulator 115, a channel emulator 130, an antenna 120, a positioning device 150, and/or any one or more components of an apparatus 200) to evaluate an accuracy of one or more LOS indicator values determined by a DUT 105 using ML. While the flowchart 400 may illustrate one order or sequencing of operations, the operations described herein may be performed in any order or sequencing. In some examples, any of the operations of the flowchart 400 may be omitted. Additionally, or alternatively, one or more operations not shown in the flowchart 400 may be added. In some examples, one or more operations of the flowchart 400 may be repeatedly performed. For example, block 405, block 410, and block 415 may be performed repeatedly (e.g., where each iteration of the process is performed for one of a plurality of LOS/NLOS configurations).

At block 405, a test configuration is setup or configured for a specific test case or scenario (e.g., for an LOS/NLOS ratio, for a specific propagation environment 300). The test case may correspond to a specific expected LOS indicator value (e.g., 10%, 20%, 30%, or the like). In some examples, setting up the test configuration may include configuring a channel emulator 130 to emulate one or more conditions that correspond to the LOS/NLOS ratio (e.g., the LOS indicator value). For example, parameters of the channel emulator 130, such as quantity of multipaths and their amplitude/elevation may be configured. Alternatively, setting up the test configuration may include positioning one or more DUTs 105, one or more antennas 120, and/or one or more reflectors 145, and/or one or more absorbers/obstacles 140 to produce the one or more conditions that correspond to the LOS/NLOS ratio. For example, one or more reflectors 145 may be placed in different locations so as to reflect one or more signals received from one or more TRPs 110 towards a DUT 105 (or another device that is calibrated and capable of precisely indicating a ratio of received LOS signals to received NLOS signals). For example, one or more absorbers/obstacles 140 may be placed in different locations so as to prevent or attenuate propagation in specific directions. In some examples, placement of reflectors 145 and/or absorbers/obstacles 140 may be based on one or more desired ground truth configurations. The positioning may be performed manually or using one or more positioning devices 150.

In some examples, the propagation environments 300 described with reference to FIG. 3 may illustrate one or more LOS/NLOS scenarios. In some examples, the test setup may be altered or adjusted incrementally as additional tests are performed (e.g., so that an array of LOS/NLOS indicator values may be tested). In such examples, the selection of reference values or a step size between tests (e.g., spacing between LOS/NLOS indicator values) may be based on a desired ML model accuracy. Additionally, or alternatively, if multiple TRPs 110 are used, LOS indicator values may be determined and communicated for each TRP 110.

At block 410, the DUT 105 may be configured to report LOS indicator values using a method having a known accuracy. For example, the TE may configure the DUT 105 to report the LOS indicator values using the method having the known accuracy. The method having the known accuracy may not utilize ML to determine LOS indicator values. In some examples, the TE may transmit one or more control signals to the DUT 105, which may configure the DUT 105 to report the LOS indicator values using the method having the known accuracy.

In some examples, the method having the known accuracy may include the following operations. The DUT 105 may be requested, subject to a capability of the DUT 105 (e.g., subject to a UE capability), to report LOS indicator values via a higher layer parameter nr-los-nlos-IndicatorRequest (see, for example, the description of the higher layer parameter nr-los-nlos-IndicatorRequest in the 3^{rd} Generation Partnership Project (3GPP) technical specification (TS) 38.214 V18.0.0 Section 5.1.6.5). The DUT 105 may report LOS indicator values via a higher layer parameter associated with each downlink (DL) reference signal time difference (RSTD), DL PRS reference signal received power (RSRP), DL PRS RSRPP, and DUT Rx-Tx time difference measurement. The DUT 105 may report LOS indicator values via a higher layer parameter nr-los-nlos-Indicator associated with each DL PRS identifier (DL-PRS-ID) in a measurement report. For the LOS indicator values associated with a DL RSTD, the DUT 105 may report one indicator associated with the DL-PRS-ID indicated by a higher layer parameter DL-PRS-ReferenceInfo and one indicator associated with the DL-PRS-ID of the DL RSTD measurement. A DUT 105 may provide LOS indicator values via a higher layer parameter nr-los-nlos-Indicator, which may be associated with each DL PRS resource of each configured DL-PRS-ID or each configured DL-PRS-ID. The values of the higher layer parameter nr-los-nlos-Indicator may be soft values (e.g., 0, 0.1, . . . , 0.9, 1) or hard (binary) values (e.g., 0, 1). Additionally, or alternatively, the values may correspond to a likelihood of communications being LOS, with a value of I corresponding to LOS communications and a value of 0 corresponding to no LOS communications. Additionally, or alternatively, the values may correspond to a likelihood of communications being NLOS, with a value of 1 corresponding to NLOS communications and a value of 0 corresponding to no NLOS communications.

At block 415, TE may transmit or cause transmission of a PRS signal to the DUT 105. The DUT 105 may then determine (e.g., estimate) one or more LOS indicator values and report the one or more LOS indicator values to the TE. The TE may then store the one or more LOS indicator values reported by the DUT 105. In some examples, the TE may store the one or more LOS indicator values with respective indicators of the corresponding channel emulation or test setup (e.g., the test configuration). In some examples, the block 405, the block 410, and the block 415 may be performed repeatedly (e.g., in a loop). Each iteration of the loop may be performed for a different channel model (e.g., a different configuration of the channel emulator 130) or different test configurations. Regardless of whether the indicator value is a binary value or a soft value, the indicator value represents a probability of the test configuration supporting LOS, or conversely NLOS, communications.

At block 420, labelled data may be generated. For example, the TE may generate the labelled data. The labelled data may include the one or more LOS indicator values determined by the DUT 105. In some examples, the labelled data may include one or more LOS indicator values determined using a method having a known accuracy and one or more corresponding LOS indicator values determined using ML. The one or more LOS indicator values determined using the method having the known accuracy may be utilized as labels for the one or more LOS indicator values determined using ML. For example, the one or more LOS indicator values determined using ML may be labelled with ground truth data (e.g., the one or more LOS indicator values determined using the method having the known accuracy).

At block 425, the ground truth data (e.g., the LOS indicator values determined using the method having the known accuracy) may be utilized to validate (e.g., in an iterative fashion) the LOS indicator values determined using artificial intelligence (AI) and/or ML functionalities (e.g., using the same channel model configurations or test operations as described above). In some examples, one or more AI/ML functionalities may be utilized to assist non-AI/ML methods for positioning (e.g., for UE positioning), among other examples. If validated, the AI/ML model may be considered to have passed the conformance test and be prepared to be placed into service, while if not validated the AI/ML model may not be placed into service and may, instead, be subjected to redesign and/or rework.

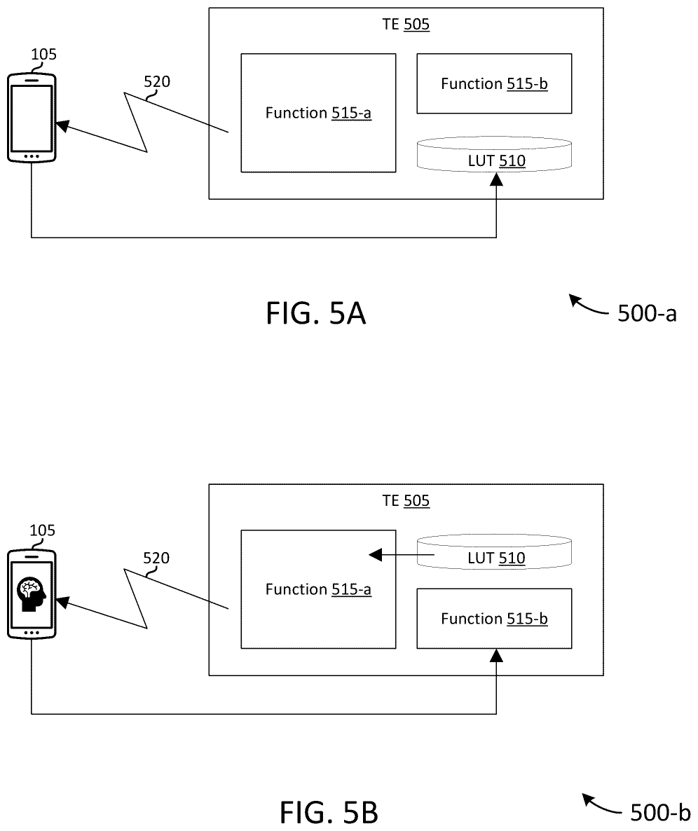

FIG. 5A illustrates an example of a signaling diagram 500-a that supports validation of machine-learning-based predictions in accordance with an example described herein. The signaling diagram 500-a may include a DUT 105 and a TE 505, which may be in communication. For example, the TE 505 may transmit or cause transmission of one or more reference signals 520 (e.g., one or more PRSs) to the DUT 105. The DUT 105 may transmit or cause transmission of one or more LOS indicator values to the TE 505, which may be stored in a table, such as a look up table (LUT) 510 of the TE 505. In some examples, the TE 505 may include one or more functions 515, which may utilize one or more values stored in the LUT 510 (e.g., for error calculations). In some examples, the signaling diagram 500-a may illustrate one or more aspects of a preparation phase (e.g., a first phase). During the preparation phase, the DUT 105 and the TE 505 may perform one or more operations to determine (e.g., measure, using a method having a known accuracy, without ML) and store one or more LOS indicator values at the TE 505 (e.g., in an LUT 510).

In some examples, the DUT 105 and the TE 505 may perform one or more operations as part of a preparation phase (e.g., a first phase). The preparation phase may include determining (e.g., by the DUT 105, by the TE 505) one or more ground truth LOS indicator values. To determine the one or more ground truth LOS indicator values, a test configuration may be set up. Setting up the test configuration may include determining if one or more reflectors and/or one or more blocking entities are to be utilized and, if so, precisely positioning the one or more reflectors and/or placing one or more blocking entities between the DUT 105 and the TE 505 (e.g., one or more TRPs, one or more antennas), selecting a quantity of TRPs, and selecting a quantity of reflectors and/or absorbers/obstacles, among other examples. After the test configuration is set up, the DUT 105 may measure a reference signal 520 (e.g., a PRS) transmitted by the TE 505 and estimate an LOS indicator value corresponding to the reference signal 520. The DUT 105 may estimate the LOS indicator value using a method having a known accuracy. For example, the DUT 105 may estimate the LOS indicator value without using AI or ML.

The DUT 105 may then report the LOS indicator value to the TE 505 and the TE 505 may store the LOS indicator value in the LUT 510. The operations described herein may then be repeatedly (e.g., iteratively) performed for a plurality of test configurations, which may enable a range of LOS indicator values to be determined and stored in the LUT 510. In one example, a first test configuration may not include any reflectors to ensure a high LOS indicator value (e.g., 100% LOS) and then subsequent test configurations (e.g., a second test configuration, a third test configuration, and so forth) may incrementally include more reflectors (e.g., to test lower LOS indicator values, such as 95% LOS, 90% LOS, and so forth). In some examples, reflectors or obstacles may not be utilized for each test configuration and various LOS indicator values may be tested by incrementally adjusting one or more parameters of a channel emulator. Repeatedly performing the operations described herein for a plurality of test configurations may enable the TE 505 to store LOS indicator values (e.g., ground truth LOS indicator values) for a plurality of test configurations. The preparation phase may be completed when the LUT 510 is filled with a specific quantity of LOS indicator values.

As shown below, Table 1 provides one illustrative example of an LUT 510. As shown, the LUT 510 may include a first column including a quantity of rows. Each element (e.g., information element (IE)) of the first column may store information indicating one or more parameters or indicators of a test configuration. For example, a first information element of the first column may indicate an identifier for the test configuration (e.g., “#1”), positional information for one or more reflectors (e.g., an absolute location of one or more reflectors, an orientation of one or more reflectors, or both), and information indicating a quantity of reflectors. In some examples, each element of the first column may store information indicating quantity information or positional information for one or more blocking entities. The LUT 510 may include a second column including a quantity of rows. Each information element of the second column may indicate an LOS indicator value (e.g., as measured by the DUT 105).

TABLE 1

| | LOS Indicator |
|---|---|
| | Value (Ground |
| Test Configuration | Truth) |
| #1 [Reflector Position, Quantity of Reflectors, . . . ] | .2 |
| #2 [Reflector Position, Quantity of Reflectors, . . . ] | .4 |
| #3 [Reflector Position, Quantity of Reflectors, . . . ] | .5 |

FIG. 5B illustrates an example of a signaling diagram 500-b that supports validation of machine-learning-based predictions in accordance with examples described herein. The signaling diagram 500-b may include a DUT 105 and a TE 505, which may be in communication. For example, the TE 505 may transmit or cause transmission of one or more reference signals 520 (e.g., one or more PRSs) to the DUT 105. The DUT 105 may transmit or cause transmission of one or more LOS indicator values to the TE 505, which may be stored in an LUT 510 or utilized by a function 515 of the TE 505. In some examples, the TE 505 may include one or more functions 515, which may utilize one or more values stored in the LUT 510 (e.g., for error calculations). In some examples, the signaling diagram 500-b may illustrate one or more aspects of a test phase (e.g., a second phase). During the test phase, the DUT 105 and the TE 505 may perform one or more operations to determine (e.g., using an ML model) and store one or more LOS indicator values at the TE 505 (e.g., in an LUT 510). Additionally, or alternatively, during the test phase, the TE 505 may determine one or more error values based on the one or more LOS indicator values determined using ML and the one or more LOS indicator values determined without using ML (e.g., during the preparation phase).

In some examples, the DUT 105 and the TE 505 may perform one or more operations as part of a test phase (e.g., a second phase). The test phase may include evaluating LOS indicator values determined using ML. For example, ground truth values for each test configuration may be extracted from the LUT 510 (e.g., the LUT 510 filled during the preparation phase). In some examples, each LOS indicator value from the LUT 510 may be represented by the expression x where the subscript g indicates ground truth and i is the indicator in the LUT 510 to identify the corresponding test configuration. In some examples, the indicator may include a set represented as i∈[1 . . . . N] where N is the size of the LUT 510 (e.g., a quantity of rows of the LUT 510) and a total quantity of test configurations.

Each test configuration stored in the LUT 510 may be applied by the TE 505. For example, the TE 505 may select one or more emulator parameters to emulate the test configuration. In some other examples, one or more reflectors/absorbers/obstacles or TRPs may be positioned to replicate the test configuration. The DUT 105 may then utilize a trained ML model to determine LOS indicator values for each test configuration. The LOS indicator values determined using the trained ML model may be referred to as x_{ML}ⁱ where the subscript ML indicates that respective LOS indicator values are obtained as an inference result of a trained ML model and i is the index corresponding to the test configuration. In some examples, the DUT 105 may report each LOS indicator value to the TE 505 (e.g., to the function 515-b of the TE 505). In some examples, the operations described herein may be repeatedly performed (e.g., for a plurality of test configurations), such that all ground truth values are tested. The TE 505 may then store all of the values estimated using ML and corresponding ground truth values. The TE 505 may then determine one or more KPIs (e.g., error values) based one or more comparisons between respective ground truth values and estimated values using ML. In some examples, the one or more KPIs may include one or more mean square error (MSE) values (e.g., MSE (x_{ML}, x_{g})).

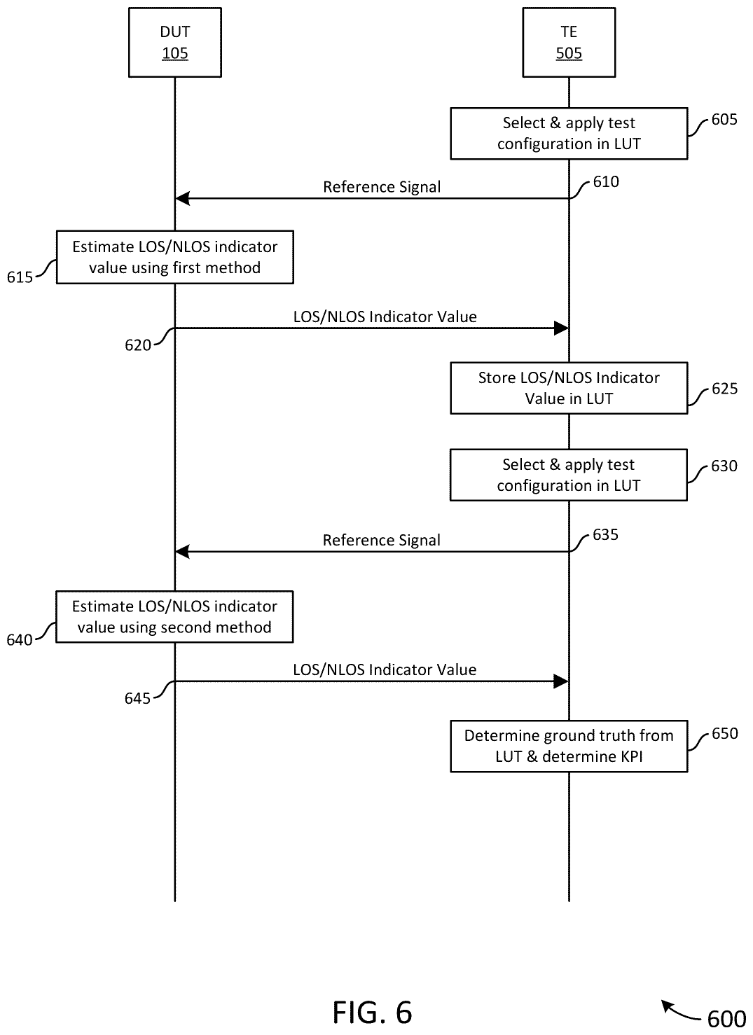

FIG. 6 illustrates an example of a signal flow diagram 600 that supports validation of machine-learning-based predictions in accordance with examples described herein. One or more operations of the signal flow diagram 600 may be performed by a DUT 105, which may be an example of a DUT 105 as described with reference to FIGS. 1, 3A, 3B, 5A, and 5B. Additionally, or alternatively, one or more operations of the signal flow diagram 600 may be performed by TE 505, which may be an example of TE 505 as described with reference to FIGS. 5A and 5B. The signal flow diagram 600 may provide one illustrative example of an order or sequencing for the operations described herein, however, any order or sequencing may be used. In some cases, one or more operations of the signal flow diagram 600 may not be performed or may otherwise be omitted. Additionally, or alternatively, the DUT 105 and the TE 505 may perform operations that are not shown in the signal flow diagram 600. It should also be understood that any of the operations described herein may be performed independently of other operations described herein. For example, the DUT 105 may receive the reference signal at 610 and may not receive the reference signal at 635.

At 605, the TE 505 may select and apply a test configuration (e.g., a first test configuration). The test configuration may correspond to one or more data objects (e.g., one or more entries, IEs, or rows of an LUT). For example, the TE 505 may select a test configuration corresponding to a first row of an LUT. The test configuration may correspond to a propagation environment or an anticipated LOS indicator value associated with the propagation environment. For example, the test configuration may be designed to create a propagation environment that results in communications between the TE 505 and the DUT being LOS communications (e.g., an LOS indicator value of “1,” an LOS indicator value of 100%). To achieve such a propagation environment, one or more objects may be positioned (e.g., in an anechoic chamber) in a specific configuration. The one or more objects may include one or more antennas that transmit and receive communications between the TE 505 and the DUT 105, one or more reflectors that reflect communications between the TE 505 and the DUT 105, and/or one or more blocking entities that block or partially block communications between the TE 505 and the DUT 105.

In some examples, positioning the one or more objects may include adjusting respective locations of the one or more objects, adjusting respective orientations of the one or more objects, or both. As one illustrative example, an antenna and the DUT 105 may be positioned such that a direct path (e.g., a straight line) can be drawn between the antenna and the DUT 105 (e.g., without any blocking entities or reflectors affecting communications between the antenna and the DUT 105). Such a test configuration may correspond to an LOS scenario (e.g., where an anticipated LOS indicator value is 100%). In some examples, a given propagation environment may be achieved (e.g., emulated) using one or more channel emulators.

At 610, the TE 505 may transmit or cause transmission of a reference signal (e.g., a first reference signal). The reference signal may be received by the DUT 105. In some examples, the reference signal may include one or more components. For example, the reference signal may be propagated along multiple paths (e.g., an LOS path and one or more NLOS paths). In some examples, the reference signal may be a PRS. Additionally, or alternatively, the reference signal may correspond to a test configuration (e.g., the reference signal may correspond to the first test configuration).

At 615, the DUT 105 may determine (e.g., estimate) an LOS indicator value (e.g., a first LOS indicator value) using a first method. The DUT 105 may determine the LOS indicator value based on the first reference signal. In some examples, the first method may include a method having a known accuracy (e.g., a method that outputs a ground truth LOS indicator value). The first method may be an example of a method that does not use ML. In some examples, the LOS indicator value may be indicative of a probability of the DUT 105 having an LOS component during reception of the first reference signal. In some examples, the LOS indicator value determined by the DUT 105 may be a probability that subsequent communications between the DUT 105 and the TE 505 will be LOS communications.

At 620, the DUT 105 may transmit or cause transmission of the LOS indicator value to the TE 505. In some examples, the LOS indicator value may be included in control signaling. Additionally, or alternatively, the DUT 105 may transmit or cause transmission of the LOS indicator value based on determining the LOS indicator value. Additionally, or alternatively, the DUT 105 may transmit or cause transmission of the LOS indicator value based on a configuration for reporting the LOS indicator value.

At 625, the TE 505 may store the LOS indicator value transmitted by the DUT 105. For example, the TE 505 may cause a data object including the LOS indicator value to be stored. In some examples, the TE 505 may store the LOS indicator value or the data object including the LOS indicator value in a table (e.g., in an LUT). The LOS indicator value may be stored in an information element or a row of the table that correspond to a test configuration (e.g., the first test configuration).

In some examples, the operations performed at 605 through 625 may be performed iteratively (e.g., repeatedly). For example, the DUT 105 and the TE 505 may perform a plurality of iterations of the operations from 605 to 625. Each iteration may be performed for a different test configuration. Each test configuration may correspond to a different propagation environment. Accordingly, performing the operations iteratively may enable the DUT 105 and the TE 505 to test a plurality of LOS indicator values (e.g., to store a plurality of ground truth LOS indicator values for subsequent comparison to corresponding LOS indicator values determined using other methods, e.g., a ML method, while subject to the same test configurations in which the ground truth LOS indicator values were determined).

At 630, the TE 505 may select and apply a test configuration (e.g., the first test configuration). The test configuration may correspond to one or more data objects (e.g., one or more entries, IEs, or rows of an LUT). For example, the TE 505 may select a test configuration corresponding to a first row of an LUT. The test configuration may correspond to a propagation environment or an anticipated LOS indicator value associated with the propagation environment. For example, the test configuration may be designed to create a propagation environment that results in communications between the TE 505 and the DUT being LOS communications (e.g., an LOS indicator value of “1,” an LOS indicator value of 100%). To achieve such a propagation environment, one or more objects may be positioned (e.g., in an anechoic chamber) in a specific configuration. The one or more objects may include one or more antennas that transmit and receive communications between the TE 505 and the DUT 105, one or more reflectors that reflect communications between the TE 505 and the DUT 105, one or more blocking entities that block or partially block communications between the TE 505 and the DUT 105.

In some examples, positioning the one or more objects may include adjusting respective locations of the one or more objects, adjusting respective orientations of the one or more objects, or both. As one illustrative example, an antenna and the DUT 105 may be positioned such that a direct path (e.g., a straight line) can be drawn between the antenna and the DUT 105 (e.g., without any blocking entities or reflectors affecting communications between the antenna and the DUT 105). Such a test configuration may correspond to an LOS scenario (e.g., where an anticipated LOS indicator value is 100%). In some examples, a given propagation environment may be achieved (e.g., emulated) using one or more channel emulators.

At 635, the TE 505 may transmit or cause transmission of a reference signal (e.g., a second reference signal). The reference signal may be received by the DUT 105. In some examples, the reference signal may include one or more components. For example, the reference signal may be propagated along multiple paths (e.g., an LOS path and one or more NLOS paths). In some examples, the reference signal may be a PRS. Additionally, or alternatively, the reference signal may correspond to a test configuration (e.g., the reference signal may correspond to the first test configuration).

At 640, the DUT 105 may determine (e.g., estimate, predict, infer) an LOS indicator value (e.g., a second LOS indicator value) using a second method. The DUT 105 may determine the LOS indicator value based on the first reference signal. In some examples, the second method may include utilizing an ML model or ML functionality (e.g., of the DUT 105). In some examples, the LOS indicator value may be indicative of a probability of the DUT 105 having an LOS component during reception of the second reference signal. In some examples, the LOS indicator value determined by the DUT 105 may be a probability that subsequent communications between the DUT 105 and the TE 505 will be LOS communications.

At 645, the DUT 105 may transmit or cause transmission of the second LOS indicator value (e.g., the ML LOS indicator value inference) to the TE 505. In some examples, the second LOS indicator value may be included in control signaling. Additionally, or alternatively, the DUT 105 may transmit or cause transmission of the second LOS indicator value based on determining the second LOS indicator value. Additionally, or alternatively, the DUT 105 may transmit or cause transmission of the second LOS indicator value based on a configuration for reporting the LOS indicator value. In some examples, upon receiving the second LOS indicator value the TE 505 may store the second LOS indicator value (e.g., in a table).

At 650, the TE 505 may determine one or more error values. In some examples, the one or more error values may be based on a comparison of the first LOS indicator value and the second LOS indicator value, both determined while in the same test configurations. In some examples, the error value may include a mean squared error. In some examples, the TE 505 may determine a key performance indicator (KPI) or a conformance test result based on the one or more error values. For example, the TE 505 may determine that the ML model passes a conformance test if the error value is below a threshold error value.

In some examples, the operations performed at 630 through 650 may be performed iteratively (e.g., repeatedly). For example, the DUT 105 and the TE 505 may perform a plurality of iterations of the operations from 630 to 650. Additionally, or alternatively, the DUT 105 and the TE 505 may perform a plurality of iterations of the operations from 605 to 650, or any other combination of operations. Each iteration may be performed for a different test configuration with the first and second LOS indicators values determined for each of the different test configurations. Each test configuration may correspond to a different propagation environment. Accordingly, performing the operations iteratively may enable the DUT 105 and the TE 505 to test a plurality of LOS indicator values (e.g., to store a plurality of LOS indicator values determined using ML for subsequent comparison to ground truth LOS indicator values).

In some examples, the TE 505 may determine respective error values for each test configuration (e.g., for each tested LOS indicator value). In such examples, the TE 505 may determine whether the ML model passes a conformance test based on each of the respective error values. In some examples, the TE 505 may determine a representative error value, such as an average error value, from the respective error values for each test configuration. Additionally, or alternatively, the TE 505 may determine whether the ML model passes the conformance test based on the average error value (e.g., for each of the test configurations). By ensuring that only the ML models that pass the conformance test are placed into service (e.g., utilized) as described above, the ML models that are placed in service will be able to accurately determine a LOS indicator value.

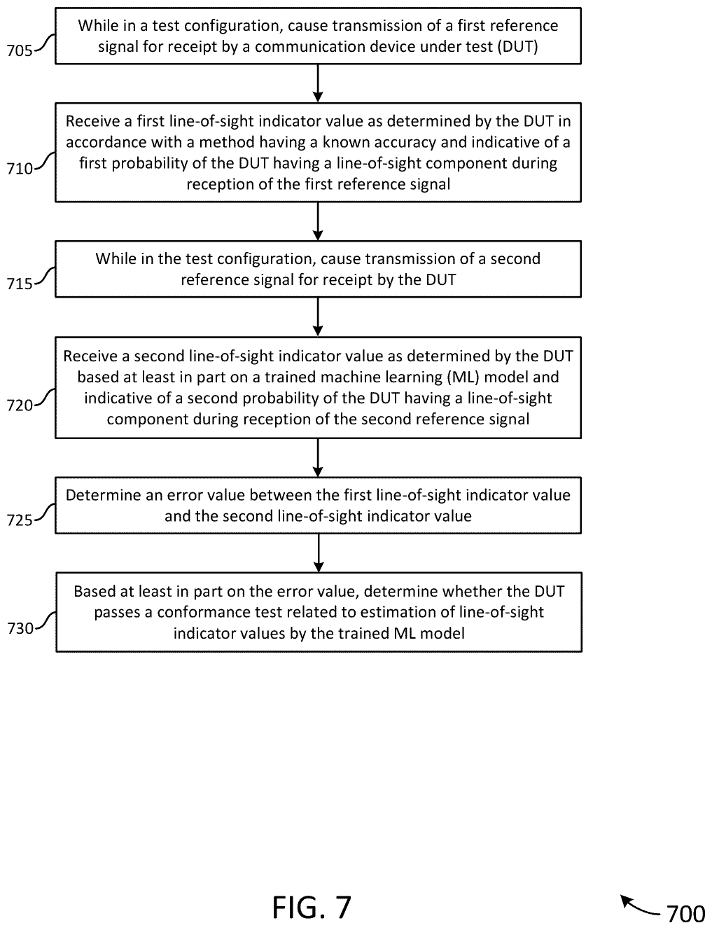

FIG. 7 illustrates an example of a flowchart 700 of the operations performed by an apparatus (e.g., an apparatus 200), such as may be embodied by a TRP, TE, or other computing device or controller, as described with reference to FIGS. 1-6.

As shown in block 705, the apparatus may include means, such as the processing circuitry 205, the communication interface 215 or the like, for, while in a test configuration, causing transmission of a first reference signal for receipt by a communication device under test (DUT).

As shown in block 710, the apparatus may include means, such as the processing circuitry 205, the communication interface 215 or the like, for receiving a first line-of-sight indicator value as determined by the DUT in accordance with a method having a known accuracy and indicative of a first probability of the DUT having a line-of-sight component during reception of the first reference signal.

As shown in block 715, the apparatus may include means, such as the processing circuitry 205, the communication interface 215 or the like, for, while in the test configuration, causing transmission of a second reference signal for receipt by the DUT.

As shown in block 720, the apparatus may include means, such as the processing circuitry 205, the communication interface 215 or the like, for receiving a second line-of-sight indicator value as determined by the DUT based at least in part on a trained machine learning (ML) model and indicative of a second probability of the DUT having a line-of-sight component during reception of the second reference signal.

As shown in block 725, the apparatus may include means, such as the processing circuitry 205 or the like, for determining an error value between the first line-of-sight indicator value and the second line-of-sight indicator value.

As shown in block 730, the apparatus may include means, such as the processing circuitry 205 or the like, for, based at least in part on the error value, determining whether the trained ML model passes a conformance test related to estimation of line-of-sight indicator values by the trained ML model. In accordance with examples described herein, any of the described operations may be performed multiple times or independently of other operations described herein.

FIGS. 4, 6 and 7 illustrate flowcharts and signal flow diagrams depicting methods according to an example embodiment. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 210 of an apparatus 200 employing an example embodiment and executed by processing circuitry 205. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-47. (canceled)

48. A method comprising:
while in a test configuration, causing transmission of a first reference signal for receipt by a communication device under test (DUT);
receiving a first line-of-sight indicator value as determined by the DUT in accordance with a method having a known accuracy and indicative of a first probability of the DUT having a line-of-sight component during reception of the first reference signal;
while in the test configuration, causing transmission of a second reference signal for receipt by the DUT, wherein the first and second reference signals are positioning reference signals;
receiving a second line-of-sight indicator value as determined by the DUT based at least in part on a trained machine learning (ML) model and indicative of a second probability of the DUT having a line-of-sight component during reception of the second reference signal;
determining an error value between the first line-of-sight indicator value and the second line-of-sight indicator value, wherein the first line-of-sight indicator value is determined in a manner independent of ML;
based at least in part on the error value, determining whether the trained ML model passes a conformance test related to estimation of line-of-sight indicator values by the trained ML model;
repeatedly causing transmission of the first reference signal and receiving the first line-of-sight indicator value for each of a plurality of different test configurations, thereby yielding a plurality of first line-of-sight indicator values; and
repeatedly causing transmission of the second reference signal and receiving the second line-of-sight indicator value for each of the plurality of different test configurations, thereby yielding a plurality of second line-of-sight indicator values;
determining a plurality of error values between the plurality of first line-of-sight indicator values and the plurality of second line-of-sight indicator values; and
determining whether the trained ML model passes the conformance test based at least in part on the plurality of error values;
determining an average error value for the plurality of error values;
determining whether the trained ML model passes the conformance test based at least in part on whether the average error value satisfies a threshold error value; and
before causing transmission of the first reference signal, configuring the DUT to determine the first line-of-sight indicator value in accordance with the method having the known accuracy; and
before causing transmission of the second reference signal, configuring the DUT to determine the second line-of-sight indicator value based at least in part on the trained ML model.

49. The method according to claim 48, further comprising:
causing a data object to be stored that comprises the first line-of-sight indicator value associated with an indication of the test configuration.

50. The method according to claim 49, further comprising:
configuring the DUT pursuant to the test configuration.

51. The method according to claim 50, wherein the test configuration is associated with a particular channel profile as emulated by a channel emulator.

52. The method according to claim 51, wherein the test configuration is associated with a particular controlled radio propagation environment comprising one line-of-sight radio propagation path and one or more non-line-of-sight radio propagation paths.

53. The method according to claim 52, wherein the test configuration comprises one or more reflectors at respective positions and respective orientations with respect to an antenna configured to transmit the first and second reference signals.

54. The method according to claim 52, wherein the test configuration comprises obstacles at respective positions and respective orientations with respect to an antenna configured to transmit the first and second reference signals.

55. An apparatus comprising:
a processor; and
a memory comprising computer-executable instructions that, when executed by the processor, cause the apparatus to perform the following operations:
while in a test configuration, causing transmission of a first reference signal for receipt by a communication device under test (DUT);
receiving a first line-of-sight indicator value as determined by the DUT in accordance with a method having a known accuracy and indicative of a first probability of the DUT having a line-of-sight component during reception of the first reference signal;
while in the test configuration, causing transmission of a second reference signal for receipt by the DUT, wherein the first and second reference signals are positioning reference signals;
receiving a second line-of-sight indicator value as determined by the DUT based at least in part on a trained machine learning (ML) model and indicative of a second probability of the DUT having a line-of-sight component during reception of the second reference signal;
determining an error value between the first line-of-sight indicator value and the second line-of-sight indicator value, wherein the first line-of-sight indicator value is determined in a manner independent of ML;
based at least in part on the error value, determining whether the trained ML model passes a conformance test related to estimation of line-of-sight indicator values by the trained ML model;
repeatedly causing transmission of the first reference signal and receiving the first line-of-sight indicator value for each of a plurality of different test configurations, thereby yielding a plurality of first line-of-sight indicator values; and
repeatedly causing transmission of the second reference signal and receiving the second line-of-sight indicator value for each of the plurality of different test configurations, thereby yielding a plurality of second line-of-sight indicator values;
determining a plurality of error values between the plurality of first line-of-sight indicator values and the plurality of second line-of-sight indicator values; and
determining whether the trained ML model passes the conformance test based at least in part on the plurality of error values;
determining an average error value for the plurality of error values;
determining whether the trained ML model passes the conformance test based at least in part on whether the average error value satisfies a threshold error value; and
before causing transmission of the first reference signal, configuring the DUT to determine the first line-of-sight indicator value in accordance with the method having the known accuracy; and
before causing transmission of the second reference signal, configuring the DUT to determine the second line-of-sight indicator value based at least in part on the trained ML model.

56. The apparatus according to claim 55, wherein the computer-executable instructions further cause the apparatus to perform the following operation:
causing a data object to be stored that comprises the first line-of-sight indicator value associated with an indication of the test configuration.

57. The apparatus according to claim 56, wherein the computer-executable instructions further cause the apparatus to perform the following operation:
configuring the DUT pursuant to the test configuration.

58. The apparatus according to claim 57, wherein the test configuration is associated with a particular channel profile as emulated by a channel emulator.

59. The apparatus according to claim 58, wherein the test configuration is associated with a particular controlled radio propagation environment comprising one line-of-sight radio propagation path and one or more non-line-of-sight radio propagation paths.

60. The apparatus according to claim 59, wherein the test configuration comprises one or more reflectors at respective positions and respective orientations with respect to an antenna configured to transmit the first and second reference signals.

61. The apparatus according to claim 59, wherein the test configuration comprises obstacles at respective positions and respective orientations with respect to an antenna configured to transmit the first and second reference signals.

62. A system comprising:
an apparatus;
a processor; and
a memory comprising computer-executable instructions that, when executed by the processor, cause the apparatus to perform the following operations:
while in a test configuration, causing transmission of a first reference signal for receipt by a communication device under test (DUT);
receiving a first line-of-sight indicator value as determined by the DUT in accordance with a method having a known accuracy and indicative of a first probability of the DUT having a line-of-sight component during reception of the first reference signal;
while in the test configuration, causing transmission of a second reference signal for receipt by the DUT, wherein the first and second reference signals are positioning reference signals;
receiving a second line-of-sight indicator value as determined by the DUT based at least in part on a trained machine learning (ML) model and indicative of a second probability of the DUT having a line-of-sight component during reception of the second reference signal;
determining an error value between the first line-of-sight indicator value and the second line-of-sight indicator value, wherein the first line-of-sight indicator value is determined in a manner independent of ML;
based at least in part on the error value, determining whether the trained ML model passes a conformance test related to estimation of line-of-sight indicator values by the trained ML model;
repeatedly causing transmission of the first reference signal and receiving the first line-of-sight indicator value for each of a plurality of different test configurations, thereby yielding a plurality of first line-of-sight indicator values; and
repeatedly causing transmission of the second reference signal and receiving the second line-of-sight indicator value for each of the plurality of different test configurations, thereby yielding a plurality of second line-of-sight indicator values;
determining a plurality of error values between the plurality of first line-of-sight indicator values and the plurality of second line-of-sight indicator values; and
determining whether the trained ML model passes the conformance test based at least in part on the plurality of error values;
determining an average error value for the plurality of error values;
determining whether the trained ML model passes the conformance test based at least in part on whether the average error value satisfies a threshold error value; and
before causing transmission of the first reference signal, configuring the DUT to determine the first line-of-sight indicator value in accordance with the method having the known accuracy; and
before causing transmission of the second reference signal, configuring the DUT to determine the second line-of-sight indicator value based at least in part on the trained ML model.

63. The system according to claim 62, wherein the computer-executable instructions further cause the apparatus to perform the following operation:
causing a data object to be stored that comprises the first line-of-sight indicator value associated with an indication of the test configuration.

64. The system according to claim 63, wherein the computer-executable instructions further cause the apparatus to perform the following operation:
configuring the DUT pursuant to the test configuration.

65. The system according to claim 64, wherein the test configuration is associated with a particular channel profile as emulated by a channel emulator.

66. The system according to claim 65, wherein the test configuration is associated with a particular controlled radio propagation environment comprising one line-of-sight radio propagation path and one or more non-line-of-sight radio propagation paths.

67. The system according to claim 66, wherein the test configuration comprises one or more reflectors at respective positions and respective orientations with respect to an antenna configured to transmit the first and second reference signals, or wherein the test configuration comprises obstacles at respective positions and respective orientations with respect to an antenna configured to transmit the first and second reference signals.
